(19) United States
(12) Patent Application Publication
(10) Pub. No.: US 2026/0121397 A1
(43) Pub. Date: Apr. 30, 2026

(54) POWER SUPPLY SYSTEM, MOVING OBJECT, AND CONTROL METHOD OF POWER SUPPLY SYSTEM

(71) Applicant: HONDA MOTOR CO., LTD., Tokyo (JP)

(72) Inventor: Kenta Shuto, Wako-shi (JP)

(21) Appl. No.: 19/362,802

(22) Filed: Oct. 20, 2025

(30) Foreign Application Priority Data
Oct. 24, 2024 (JP) 2024-187571

(51) Int. Cl. H02H 3/08; B64D 27/35

(52) U.S. Cl. CPC H02H 3/08; B64D 27/35; B64D 2221/00

(57) ABSTRACT

In a power supply system, in a case where an overcurrent determination unit determines that a load device-side current, which is a current supplied from a power supply circuit to a load device, is an overcurrent, load disconnection control for disconnecting a VTOL electric motor or a cruise electric motor from the power supply circuit is executed on a drive device, and in a case where a state in which the load device-side current is an overcurrent continues even though the load disconnection control has been executed, power generation device disconnection control for disconnecting a power generation device from the power supply circuit is executed on a first disconnection device.

### CROSS-REFERENCE TO RELATED APPLICATIONS

This application is based upon and claims the benefit of priority from Japanese Patent Application No. 2024-187571 filed on Oct. 24, 2024, the contents of which are incorporated herein by reference.

### BACKGROUND OF THE INVENTION

### Field of the Invention

The present disclosure relates to a power supply system, a moving object, and a control method of the power supply system.

### Description of the Related Art

JP 2022-529997 A discloses an aircraft electrical energy supply network (power supply system).

### SUMMARY OF THE INVENTION

There has been a demand for a more satisfactory power supply system, a moving object including the more satisfactory power supply system, and a more satisfactory control method of the power supply system.

The present disclosure has the object of solving the above-described problem.

According to a first aspect of the present disclosure, there is provided a power supply system comprising: a power generation device configured to output direct current electric power; a load device including a drive device configured to convert the direct current electric power into alternating current electric power to drive a load; a power supply circuit configured to supply, to the load device, the direct current electric power supplied from the power generation device; a first disconnection device configured to disconnect the power generation device from the power supply circuit; an overcurrent determination unit configured to determine whether or not a load device-side current that is a current supplied from the power supply circuit to the load device is an overcurrent; and a control unit configured to control the drive device and the first disconnection device, wherein the control unit executes, on the drive device, load disconnection control for disconnecting the load from the power supply circuit, in a case where the overcurrent determination unit determines that the load device-side current is the overcurrent; and the control unit executes, on the first disconnection device, power generation device disconnection control for disconnecting the power generation device from the power supply circuit, in a case where a state in which the load device-side current is the overcurrent continues even though the load disconnection control has been executed.

According to a second aspect of the present disclosure, there is provided a moving object comprising the power supply system according to the first aspect.

According to a third aspect of the present disclosure, there is provided a control method of a power supply system, the power supply system including: a power generation device configured to output direct current electric power; a load device including a drive device configured to convert the direct current electric power into alternating current electric power to drive a load; a power supply circuit configured to supply, to the load device, the direct current electric power supplied from the power generation device; a first disconnection device configured to disconnect the power generation device from the power supply circuit; and an overcurrent determination unit configured to determine whether or not a load device-side current that is a current supplied from the power supply circuit to the load device is an overcurrent, the control method comprising: executing, on the drive device, load disconnection control for disconnecting the load from the power supply circuit, in a case where the overcurrent determination unit determines that the load device-side current is the overcurrent; and executing, on the first disconnection device, power generation device disconnection control for disconnecting the power generation device from the power supply circuit, in a case where a state in which the load device-side current is the overcurrent continues even though the load disconnection control has been executed.

According to the present disclosure, it is possible to provide a more satisfactory power supply system, a moving object including the more satisfactory power supply system, and a more satisfactory control method of the power supply system.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a moving object according to an embodiment of the present disclosure;

FIG. 2 is a schematic diagram showing a configuration of a power supply system according to the embodiment;

FIG. 3 is a block diagram showing a configuration of a control device according to the embodiment;

FIG. 4 is a flowchart showing a flow of disconnection control executed by the control device in the embodiment;

FIG. 5 is a diagram showing an operation of the power supply system in the embodiment;

FIG. 6 is a diagram showing the operation of the power supply system in the embodiment; and

FIG. 7 is a diagram showing the operation of the power supply system in the embodiment.

### DETAILED DESCRIPTION OF THE INVENTION

Conventionally, a power supply system mounted on an electric vertical take-off and landing aircraft (eVTOL aircraft) has been disclosed. The power supply system includes a power generation device, a load device, and a power supply circuit. The power generation device converts the AC power generated by a generator into DC power and outputs the DC power. The power supply circuit supplies, to the load device, the DC power supplied from the power generation device. The load device converts the DC power supplied from the power supply circuit into AC power and is driven by the AC power.

Conventionally, in the case where a short circuit occurs in the load device, the power generation device is disconnected from the power supply circuit by a disconnection device. In the case where the power generation device is disconnected from the power supply circuit, the load of the power generation device decreases, and the rotational speed of the power generation device therefore increases. In this case, the power generation device is sometimes stopped in order to protect the power generation device.

According to the power supply system of the present disclosure, even when a short circuit occurs in the load device, it is possible to reduce cases in which the power generation device is stopped.

### Embodiment

### [Configuration of Moving Object]

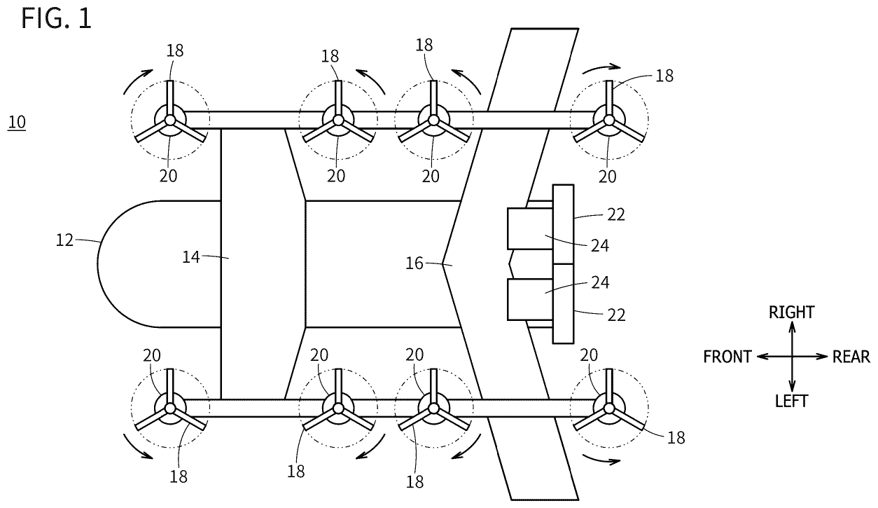

FIG. 1 is a schematic diagram of a moving object 10 according to an embodiment of the present disclosure. The moving object 10 of the embodiment is an electric vertical take-off and landing aircraft (eVTOL aircraft). The moving object 10 includes a fuselage 12. The fuselage 12 is provided with a cockpit, a cabin, and the like. A pilot rides in the cockpit and controls the moving object 10. Passengers and the like ride in the cabin. The moving object 10 may be automatically controlled.

The moving object 10 includes a front wing 14 and a rear wing 16. In the case where the moving object 10 moves forward, lift is generated in each of the front wing 14 and the rear wing 16.

The moving object 10 includes eight VTOL rotors 18 and two cruise rotors 22. One VTOL electric motor 20 is provided for one VTOL rotor 18. The VTOL electric motor 20 is a single three-phase motor. One cruise electric motor 24 is provided for one cruise rotor 22. The cruise electric motor 24 is a dual three-phase motor.

### [Configuration of Power Supply System]

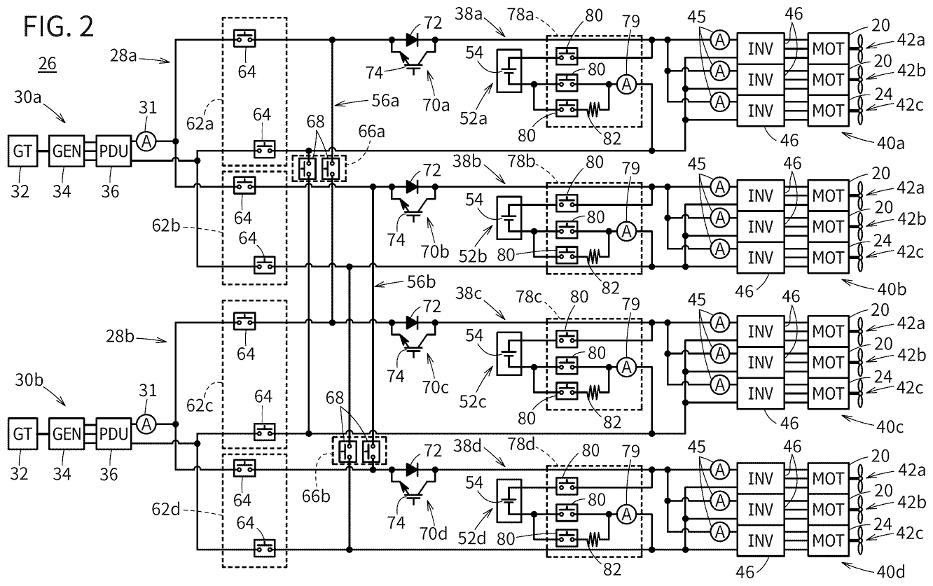

FIG. 2 is a schematic diagram showing a configuration of a power supply system 26 according to the embodiment. The power supply system 26 includes two power supply subsystems, that is, a first power supply subsystem 28a and a second power supply subsystem 28b. The power supply system 26 includes two power generation devices 30 as main power sources. The two power generation devices 30 are a power generation device 30a and a power generation device 30b. The power generation device 30a is provided in the first power supply subsystem 28a, and the power generation device 30b is provided in the second power supply subsystem 28b.

Each of the power generation devices 30 includes a gas turbine 32, a generator 34, and a power drive unit (hereinafter, referred to as a PDU) 36. The gas turbine 32 drives the generator 34. As a result, the generator 34 generates electric power. The PDU 36 converts the AC power generated by the generator 34 into DC power, and outputs the DC power. In the case where the gas turbine 32 is started, the PDU 36 converts the DC power input to the PDU 36 into AC power, and outputs the AC power to the generator 34. The generator 34 is operated by the AC power, and the generator 34 causes the gas turbine 32 to be started.

The power generation devices 30 each include a current sensor 31. The current sensor 31 detects the current of electric power input to and output from each power generation device 30. The current sensor 31 is provided on the positive wire, but may be provided on the negative wire.

The power generation devices 30 may each include various sensors such as a voltage sensor, and elements such as a fuse, a relay, a breaker, a diode, a transistor, a resistor, a coil, and a capacitor.

The power supply system 26 includes four power supply circuits 38. The four power supply circuits 38 are a power supply circuit 38a, a power supply circuit 38b, a power supply circuit 38c, and a power supply circuit 38d.

The power supply system 26 includes four load modules 40. The four load modules 40 are a load module 40a, a load module 40b, a load module 40c, and a load module 40d.

The power supply circuit 38a supplies, to the load module 40a, the DC power supplied from the power generation device 30a. The power supply circuit 38b supplies, to the load module 40b, the DC power supplied from the power generation device 30a. The power supply circuit 38c supplies, to the load module 40c, the DC power supplied from the power generation device 30b of the second power supply subsystem 28b. The power supply circuit 38d supplies, to the load module 40d, the DC power supplied from the power generation device 30b of the second power supply subsystem 28b.

The load modules 40 each include three load devices 42. The three load devices 42 are a load device 42a, a load device 42b, and a load device 42c.

The load device 42a and the load device 42b each include a drive device 46 and the VTOL electric motor 20. The load device 42c includes the drive device 46 and the cruise electric motor 24. The drive device 46 is an inverter including a switching element. By controlling the switching element, the drive device 46 converts the DC power input to the drive device 46 into three-phase AC power, and outputs the three-phase AC power to the VTOL electric motor 20 or the cruise electric motor 24. By controlling the switching element, the drive device 46 can disconnect the load device 42 from the power supply circuit 38.

It should be noted that the cruise electric motor 24 of the load device 42c of the load module 40a and the cruise electric motor 24 of the load device 42c of the load module 40c are the same electric motor. Further, the cruise electric motor 24 of the load device 42c of the load module 40b and the cruise electric motor 24 of the load device 42c of the load module 40d are the same electric motor. As described above, the cruise electric motor 24 is a dual three-phase motor and is driven by two drive devices 46.

The load devices 42 each include a current sensor 45. The current sensor 45 detects the current of electric power input to and output from each load device 42. The current sensor 45 is provided on the positive wire, but may be provided on the negative wire.

The load devices 42 may each include various sensors such as a voltage sensor, and elements such as a fuse, a relay, a breaker, a diode, a transistor, a resistor, a coil, and a capacitor.

The power supply system 26 includes four power storage devices 52. The four power storage devices 52 are a power storage device 52a, a power storage device 52b, a power storage device 52c, and a power storage device 52d. The power storage device 52 is connected to each power supply circuit 38. The power storage device 52 is connected in parallel with the power generation device 30. The power storage devices 52 each include a battery 54. The battery 54 is, for example, a lithium ion battery.

The power storage devices 52 may each include various sensors such as a voltage sensor, and elements such as a fuse, a relay, a breaker, a diode, a transistor, a resistor, a coil, and a capacitor.

The power supply circuit 38a and the power supply circuit 38c are connected by a connection circuit 56a. The power supply circuit 38b and the power supply circuit 38d are connected by a connection circuit 56b.

The power supply system 26 includes four first disconnection devices 62. The four first disconnection devices 62 are a first disconnection device 62a, a first disconnection device 62b, a first disconnection device 62c, and a first disconnection device 62d. The first disconnection devices 62 each include two contactors 64. One contactor 64 is provided on the positive wire, and another contactor 64 is provided on the negative wire.

The first disconnection device 62a can disconnect the power generation device 30a from the power supply circuit 38a. The first disconnection device 62b can disconnect the power generation device 30a from the power supply circuit 38b. The first disconnection device 62c can disconnect the power generation device 30b from the power supply circuit 38c. The first disconnection device 62d can disconnect the power generation device 30b from the power supply circuit 38d.

The power supply system 26 includes two connection devices 66. The two connection devices 66 are a connection device 66a and a connection device 66b. The connection devices 66 each include two contactors 68. One contactor 68 is provided on the positive wire, and another contactor 68 is provided on the negative wire.

The connection device 66a can connect the power supply circuit 38a and the power supply circuit 38c via the connection circuit 56a. The connection device 66b can connect the power supply circuit 38b and the power supply circuit 38d via the connection circuit 56b.

The power supply system 26 includes four backflow prevention devices 70. The four backflow prevention devices 70 are a backflow prevention device 70a, a backflow prevention device 70b, a backflow prevention device 70c, and a backflow prevention device 70d. The backflow prevention device 70a is provided at the positive electrode of the power supply circuit 38a. The backflow prevention device 70b is provided at the positive electrode of the power supply circuit 38b. The backflow prevention device 70c is provided at the positive electrode of the power supply circuit 38c. The backflow prevention device 70d is provided at the positive electrode of the power supply circuit 38d. Each backflow prevention device 70 may be provided at the negative electrode of each power supply circuit 38.

The backflow prevention devices 70 each include a diode 72, and an insulated gate bipolar transistor (hereinafter, referred to as IGBT) 74. In the case where the IGBT 74 is OFF, the diode 72 prevents a backflow of the current in each of the power supply circuit 38a, the power supply circuit 38b, the power supply circuit 38c, and the power supply circuit 38d. In the case where the IGBT 74 is ON, by bypassing the diode 72, the backflow of the current is allowed in each of the power supply circuits 38. Each of the backflow prevention devices 70 may be constituted by a contactor, a relay, or the like instead of the IGBT 74.

The power supply system 26 includes four second disconnection devices 78. The four second disconnection devices 78 are a second disconnection device 78a, a second disconnection device 78b, a second disconnection device 78c, and a second disconnection device 78d.

The second disconnection devices 78 each include three contactors 80 and one precharge resistor 82. One contactor 80 of the three contactors 80 is provided on the positive wire. Another contactor 80 of the three contactors 80 is provided on the negative wire. Still another contactor 80 of the three contactors 80 is provided in a precharge circuit that bypasses the contactor 80 provided on the negative wire. The precharge resistor 82 is provided in series with the contactor 80 in the precharge circuit.

The second disconnection device 78a can disconnect the power storage device 52a from the power supply circuit 38a. The second disconnection device 78b can disconnect the power storage device 52b from the power supply circuit 38b. The second disconnection device 78c can disconnect the power storage device 52c from the power supply circuit 38c. The second disconnection device 78d can disconnect the power storage device 52d from the power supply circuit 38d.

In the case where the power generation device 30a and the load module 40a are precharged with the DC power of the power storage device 52a, the second disconnection device 78a outputs the DC power from the power storage device 52a to the power supply circuit 38a via the precharge circuit. In the case where the power generation device 30a and the load module 40b are precharged with the DC power of the power storage device 52b, the second disconnection device 78b outputs the DC power from the power storage device 52b to the power supply circuit 38b via the precharge circuit. In the case where the power generation device 30b and the load module 40c are precharged with the DC power of the power storage device 52c, the second disconnection device 78c outputs the DC power from the power storage device 52c to the power supply circuit 38c via the precharge circuit. In the case where the power generation device 30b and the load module 40d are precharged with the DC power of the power storage device 52d, the second disconnection device 78d outputs the DC power from the power storage device 52d to the power supply circuit 38d via the precharge circuit.

The second disconnection devices 78 each include a current sensor 79. The current sensor 79 detects the current of electric power input to and output from each second disconnection device 78.

### [Configuration of Control Device]

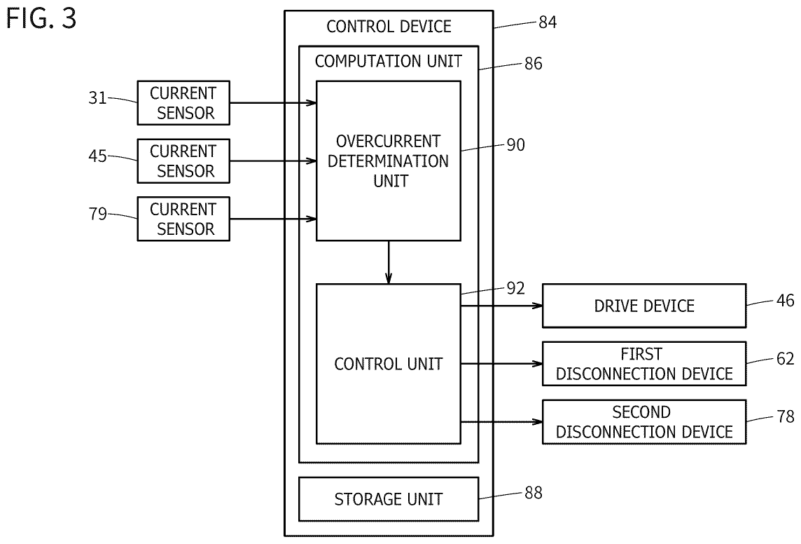

The power supply system 26 includes a control device 84 that controls the drive devices 46, the first disconnection devices 62, and the second disconnection devices 78. FIG. 3 is a block diagram showing a configuration of the control device 84 according to the embodiment.

The control device 84 includes a computation unit 86 and a storage unit 88. The computation unit 86 is, for example, a processor such as a central processing unit (CPU) or a graphics processing unit (GPU). The computation unit 86 includes an overcurrent determination unit 90 and a control unit 92. The overcurrent determination unit 90 and the control unit 92 are realized by the computation unit 86 executing a program stored in the storage unit 88. At least part of the overcurrent determination unit 90 and the control unit 92 may be realized by an integrated circuit such as an application specific integrated circuit (ASIC) or a field-programmable gate array (FPGA). At least part of the overcurrent determination unit 90 and the control unit 92 may be realized by an electronic circuit including a discrete device.

The storage unit 88 is a computer-readable non-transitory tangible storage medium. The storage unit 88 is constituted by a volatile memory (not shown) and a non-volatile memory (not shown). The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least a part of the storage unit 88 may be included in the processor, the integrated circuit, or the like described above. At least a part of the storage unit 88 may be mounted on a device connected to the moving object 10 via a network.

The overcurrent determination unit 90 determines whether or not a load device-side current, which is a current supplied from each power supply circuit 38 to each load device 42, is an overcurrent. In the case where the value of the current acquired from the current sensor 45 is equal to or greater than a predetermined current value, the overcurrent determination unit 90 determines that the load device-side current is an overcurrent.

The overcurrent determination unit 90 determines whether or not a power generation device-side current, which is a current supplied from each power generation device 30 to each power supply circuit 38, is an overcurrent. In the case where the value of the current acquired from the current sensor 31 is equal to or greater than a predetermined current value, the overcurrent determination unit 90 determines that the power generation device-side current is an overcurrent.

The overcurrent determination unit 90 determines whether or not a power storage device-side current, which is a current supplied from each power storage device 52 to each power supply circuit 38, is an overcurrent. In the case where the value of the current acquired from the current sensor 79 is equal to or greater than a predetermined current value, the overcurrent determination unit 90 determines that the power storage device-side current is an overcurrent.

In the overcurrent determination unit 90, the predetermined current value that is a threshold for determining that the load device-side current is an overcurrent, the predetermined current value that is a threshold for determining that the power generation device-side current is an overcurrent, and the predetermined current value that is a threshold for determining that the power storage device-side current is an overcurrent may be the same value or may be different values.

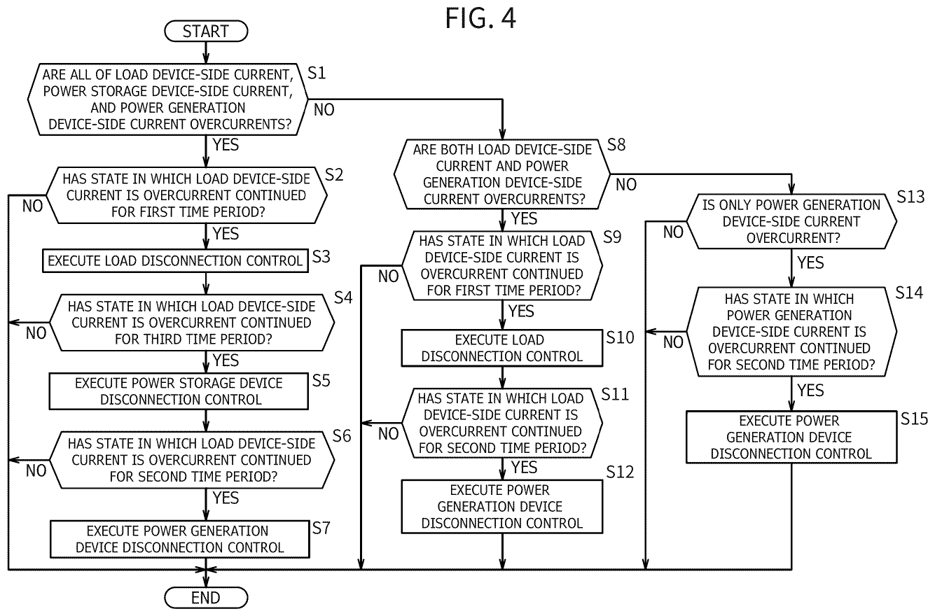

The control unit 92 controls each first disconnection device 62, each second disconnection device 78, and each drive device 46 according to the determination result of the overcurrent determination unit 90. It should be noted that the first disconnection device 62 and the second disconnection device 78 may be controlled by one control unit 92, and the drive device 46 may be controlled by another control unit 92. Further, the first disconnection device 62, the second disconnection device 78, and the drive device 46 may be controlled by different control units 92. The control of the first disconnection device 62, the second disconnection device 78 and the drive device 46 will be described below with reference to the flowchart of FIG. 4.

### [Disconnection Control]

FIG. 4 is a flowchart showing a flow of disconnection control executed by the control device 84 in the embodiment. The disconnection control is repeatedly executed at a predetermined cycle.

In step S1, the control unit 92 determines whether or not all of the load device-side current, the power storage device-side current, and the power generation device-side current are overcurrents. In the case where it is determined that all of the load device-side current, the power storage device-side current, and the power generation device-side current are overcurrents (step S1: YES), the process proceeds to step S2.

In step S2, the control unit 92 determines whether or not a state in which the load device-side current is an overcurrent has continued for a first time period. In the case where it is determined that the state in which the load device-side current is an overcurrent has continued for the first time period (step S2: YES), the process proceeds to step S3. In the case where it is determined that the state in which the load device-side current is an overcurrent is removed before the first time period elapses (step S2: NO), the disconnection control is ended.

In step S3, the control unit 92 performs load disconnection control on the drive device 46. Thereafter, the process proceeds to step S4. The load disconnection control is control for controlling the switching element of the drive device 46 to disconnect the VTOL electric motor 20 or the cruise electric motor 24, which is a load, from the power supply circuit 38.

For example, in the case where it is determined that the load device-side current is an overcurrent in one load device 42 among the three load devices 42 of the load module 40a shown in FIG. 2, the load disconnection control is executed on the drive device 46 of the one load device 42 for which the load device-side current is determined to be an overcurrent. In the case where it is determined that the load device-side current is an overcurrent in one load device 42 among the three load devices 42 of the load module 40a, the load disconnection control may be executed on the drive devices 46 of all the load devices 42 of the load module 40a.

In step S4, the control unit 92 determines whether or not the state in which the load device-side current is an overcurrent has continued for a third time period. In the case where it is determined that the state in which the load device-side current is an overcurrent has continued for the third time period (step S4: YES), the process proceeds to step S5. In the case where it is determined that the state in which the load device-side current is an overcurrent is removed before the third time period elapses (step S4: NO), the disconnection control is ended. The third time period is longer than the first time period.

In step S5, the control unit 92 executes power storage device disconnection control on the second disconnection device 78. Thereafter, the process proceeds to step S6. The power storage device disconnection control is control for disconnecting the power storage device 52 from the power supply circuit 38 by bringing the second disconnection device 78 into a disconnection state.

For example, in the case where the state in which the load device-side current is an overcurrent still continues even though the load disconnection control has been executed on the drive device 46 of the load device 42 of the load module 40a, the power storage device disconnection control is executed on the second disconnection device 78a.

In step S6, the control unit 92 determines whether or not the state in which the load device-side current is an overcurrent has continued for a second time period. In the case where it is determined that the state in which the load device-side current is an overcurrent has continued for the second time period (step S6: YES), the process proceeds to step S7. In the case where it is determined that the state in which the load device-side current is an overcurrent is removed before the second time period elapses (step S6: NO), the disconnection control is ended. The second time period is longer than the first time period. The second time period is longer than the third time period. The second time period may have the same length as the third time period.

In step S7, the control unit 92 executes power generation device disconnection control on the first disconnection device 62. Thereafter, the disconnection control is ended. The power generation device disconnection control is control for disconnecting the power generation device 30 from the power supply circuit 38 by bringing the first disconnection device 62 into a disconnection state.

For example, in the case where the state in which the load device-side current is an overcurrent still continues even though the power storage device disconnection control has been executed on the second disconnection device 78a, the power generation device disconnection control is executed on the first disconnection device 62a.

In the case where it is determined that any of the load device-side current, the power storage device-side current, and the power generation device-side current is not an overcurrent (step S1: NO), the process proceeds to step S8.

In step S8, the control unit 92 determines whether or not both the load device-side current and the power generation device-side current are overcurrents. In the case where it is determined that both the load device-side current and the power generation device-side current are overcurrents (step S8: YES), the process proceeds to step S9.

In step S9, the control unit 92 determines whether or not the state in which the load device-side current is an overcurrent has continued for the first time period. In the case where it is determined that the state in which the load device-side current is an overcurrent has continued for the first time period (step S9: YES), the process proceeds to step S10. In the case where it is determined that the state in which the load device-side current is an overcurrent is removed before the first time period elapses (step S9: NO), the disconnection control is ended.

In step S10, the control unit 92 executes the load disconnection control on the drive device 46. Thereafter, the process proceeds to step S11.

In step S11, the control unit 92 determines whether or not the state in which the load device-side current is an overcurrent has continued for the second time period. In the case where it is determined that the state in which the load device-side current is an overcurrent has continued for the second time period (step S11: YES), the process proceeds to step S12. In the case where it is determined that the state in which the load device-side current is an overcurrent is removed before the second time period elapses (step S11: NO), the disconnection control is ended.

In step S12, the control unit 92 executes the power generation device disconnection control on the first disconnection device 62. Thereafter, the disconnection control is ended.

In the case where it is determined that either the load device-side current or the power generation device-side current is not an overcurrent (step S8: NO), the process proceeds to step S13.

In step S13, the control unit 92 determines whether or not only the power generation device-side current is an overcurrent. In the case where it is determined that only the power generation device-side current is an overcurrent (step S13: YES), the process proceeds to step S14. In the case where it is determined that the power generation device-side current is not an overcurrent (step S13: NO), the disconnection control is ended.

In step S14, the control unit 92 determines whether or not a state in which the power generation device-side current is an overcurrent has continued for the second time period. In the case where it is determined that the state in which the power generation device-side current is an overcurrent has continued for the second time period (step S14: YES), the process proceeds to step S15. In the case where it is determined that the state in which the power generation device-side current is an overcurrent is removed before the second time period elapses (step S14: NO), the disconnection control is ended.

In step S15, the control unit 92 executes the power generation device disconnection control on the first disconnection device 62. Thereafter, the disconnection control is ended.

It should be noted that, in the disconnection control, the processes of steps S8 to S15 may be performed without performing the processes of steps S1 to S7.

### [Operation of Power Supply System]

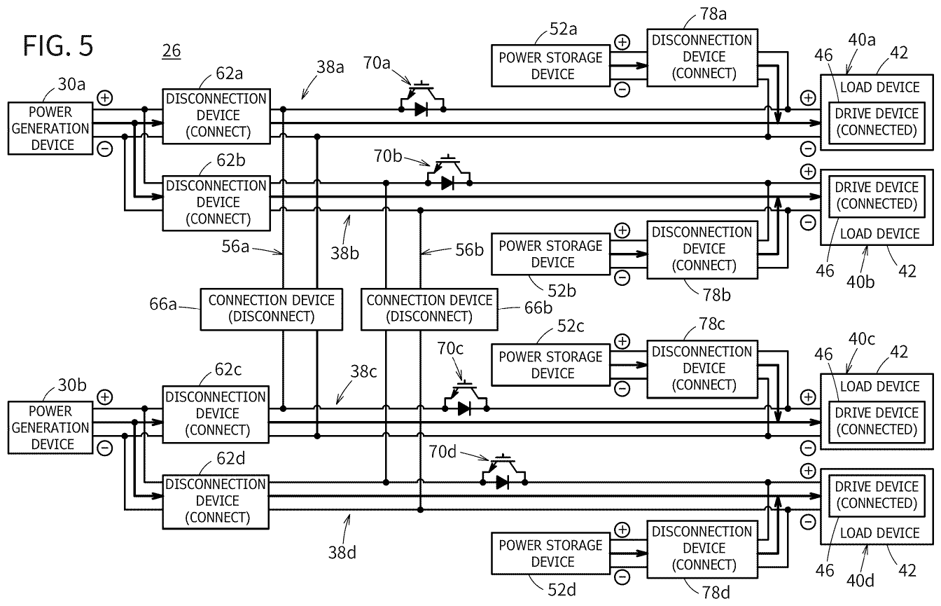

The operation of the power supply system 26 will be described with reference to FIGS. 5 to 7. FIGS. 5 to 7 show the power supply system 26 in a simplified manner. The bold arrows shown in FIGS. 5 to 7 indicate electric power supply paths.

### (Operation of Power Supply System in Normal State)

FIG. 5 is a diagram showing the operation of the power supply system 26 in a normal state in the embodiment.

The power generation device 30a is connected to the power supply circuit 38a by the first disconnection device 62a, and DC power is supplied from the power generation device 30a to the load device 42 of the load module 40a. The power generation device 30a is connected to the power supply circuit 38b by the first disconnection device 62b, and DC power is supplied from the power generation device 30a to the load device 42 of the load module 40b. The power generation device 30b is connected to the power supply circuit 38c by the first disconnection device 62c, and DC power is supplied from the power generation device 30b to the load device 42 of the load module 40c. The power generation device 30b is connected to the power supply circuit 38d by the first disconnection device 62d, and DC power is supplied from the power generation device 30b to the load device 42 of the load module 40d.

The power storage device 52a is connected to the power supply circuit 38a by the second disconnection device 78a, and DC power is supplied from the power storage device 52a to the load device 42 of the load module 40a. The power storage device 52b is connected to the power supply circuit 38b by the second disconnection device 78b, and DC power is supplied from the power storage device 52b to the load device 42 of the load module 40b. The power storage device 52c is connected to the power supply circuit 38c by the second disconnection device 78c, and DC power is supplied from the power storage device 52c to the load device 42 of the load module 40c. The power storage device 52d is connected to the power supply circuit 38d by the second disconnection device 78d, and DC power is supplied from the power storage device 52d to the load device 42 of the load module 40d.

The connection between the power supply circuit 38a and the power supply circuit 38c is interrupted by the connection device 66a, and the connection between the power supply circuit 38b and the power supply circuit 38d is interrupted by the connection device 66b.

### (Operation of Power Supply System in Case Where Short Circuit Occurs in Load Device)

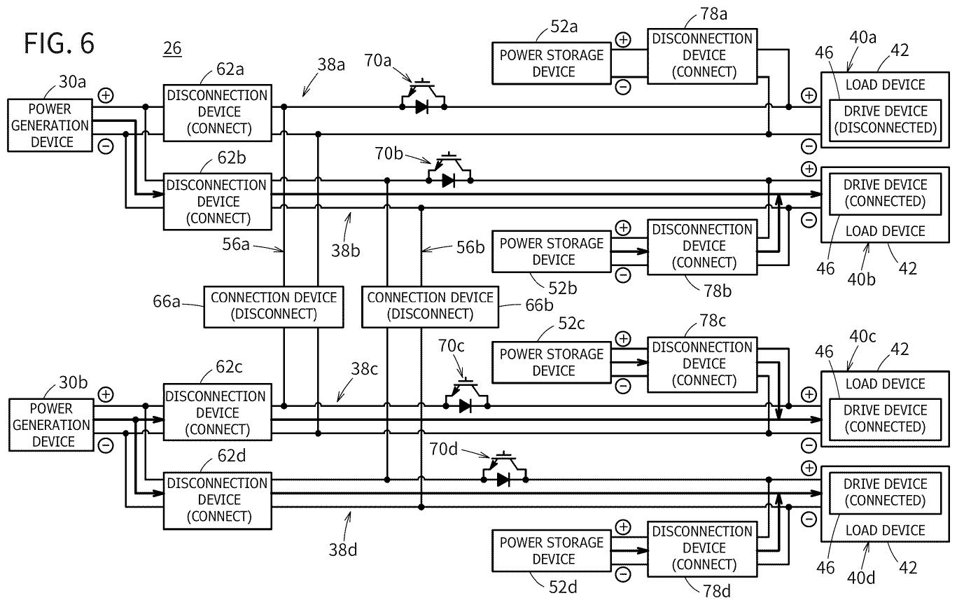

FIG. 6 is a diagram showing the operation of the power supply system 26 in the case where a short circuit occurs in the load device 42 of the load module 40a in the embodiment.

In the case where a short circuit occurs in the load device 42 of the load module 40a, the overcurrent determination unit 90 of the control device 84 determines that the load device-side current supplied from the power supply circuit 38a to the load device 42 of the load module 40a is an overcurrent. In addition, the overcurrent determination unit 90 determines that the power storage device-side current supplied from the power storage device 52a to the power supply circuit 38a is an overcurrent. Further, the overcurrent determination unit 90 determines that the power generation device-side current supplied from the power generation device 30a to the power supply circuit 38a is an overcurrent.

In this case, the control unit 92 of the control device 84 executes load disconnection control for disconnecting the load device 42 of the load module 40a from the power supply circuit 38a, on the drive device 46 included in the load device 42 of the load module 40a (FIG. 6). Even when the load disconnection control is executed on the drive device 46 included in the load device 42 of the load module 40a, electric power can be supplied from the power generation device 30a to the load device 42 of the load module 40b. Therefore, a rapid decrease in the load of the power generation device 30a is suppressed, and the power generation device 30a can be prevented from stopping.

In the case where the state in which the load device-side current is an overcurrent still continues even though the load disconnection control has been executed on the drive device 46 included in the load device 42 of the load module 40a, the control unit 92 executes, on the second disconnection device 78a, power storage device disconnection control for disconnecting the power storage device 52a from the power supply circuit 38a.

In the case where the state in which the load device-side current is an overcurrent still continues even though the power storage device disconnection control has been executed on the second disconnection device 78a, the control unit 92 executes, on the first disconnection device 62a, power generation device disconnection control for disconnecting the power generation device 30a from the power supply circuit 38a.

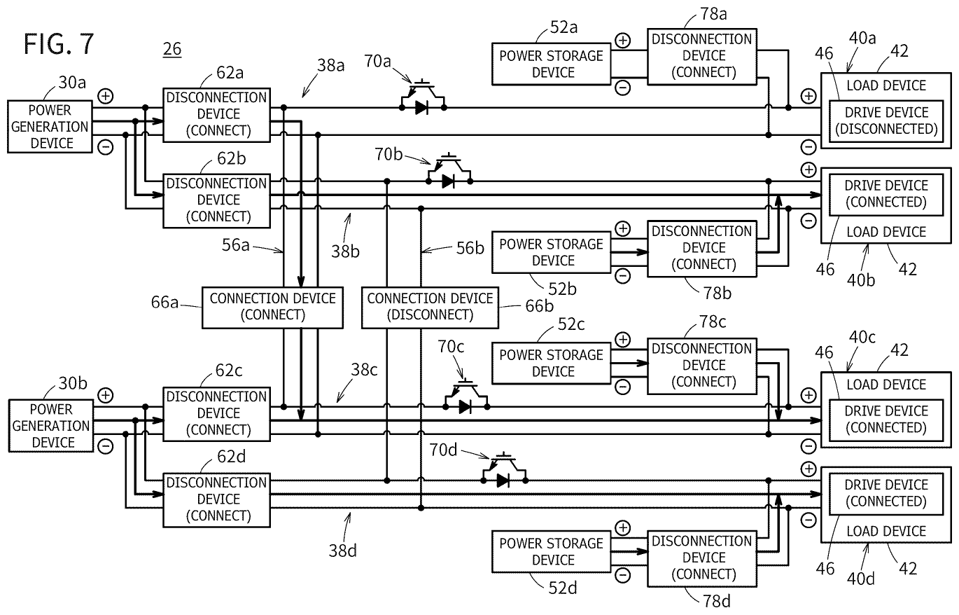

FIG. 7 is a diagram showing the operation of the power supply system 26 in the case where it is determined that the load device-side current is not an overcurrent after the load disconnection control is executed on the drive device 46 included in the load device 42 of the load module 40a in the embodiment.

In the case where it is determined that the load device-side current is not an overcurrent after the load disconnection control is executed on the drive device 46 included in the load device 42 of the load module 40a, the control unit 92 may execute, on the connection device 66a, connection control for connecting the power supply circuit 38a and the power supply circuit 38c via the connection circuit 56a.

The following supplementary notes are further disclosed in relation to the above-described embodiment.

### Supplementary Note 1

The power supply system (26) of the present disclosure includes: the power generation device (30) configured to output DC power; the load device (42) including the drive device (46) configured to convert the DC power into AC power to drive the load; the power supply circuit (38) configured to supply, to the load device, the DC power supplied from the power generation device; the first disconnection device (62) configured to disconnect the power generation device from the power supply circuit; the overcurrent determination unit (90) configured to determine whether or not the load device-side current that is a current supplied from the power supply circuit to the load device is an overcurrent; and the control unit (92) configured to control the drive device and the first disconnection device, wherein the control unit executes, on the drive device, the load disconnection control for disconnecting the load from the power supply circuit, in the case where the overcurrent determination unit determines that the load device-side current is an overcurrent, and the control unit executes, on the first disconnection device, the power generation device disconnection control for disconnecting the power generation device from the power supply circuit, in the case where the state in which the load device-side current is an overcurrent continues even though the load disconnection control has been executed. This can prevent the power generation device from stopping.

### Supplementary Note 2

In the power supply system according to Supplementary Note 1, the overcurrent determination unit may further determine whether or not the power generation device-side current that is a current supplied from the power generation device to the power supply circuit is an overcurrent, the control unit may execute the load disconnection control on the drive device in the case where the overcurrent determination unit determines that both the load device-side current and the power generation device-side current are overcurrents, and the control unit may execute the power generation device disconnection control on the first disconnection device in the case where the state in which the power generation device-side current is an overcurrent continues even though the load disconnection control has been executed. This can prevent the power generation device from stopping.

### Supplementary Note 3

The power supply system according to Supplementary Note 2 may further include: the power storage device (52) connected to the power supply circuit in parallel with the power generation device; and the second disconnection device (78) configured to disconnect the power storage device from the power supply circuit, wherein the overcurrent determination unit may further determine whether or not the power storage device-side current that is a current supplied from the power storage device to the power supply circuit is an overcurrent, the control unit may execute the load device disconnection control on the drive device in the case where the overcurrent determination unit determines that both the load device-side current and the power storage device-side current are overcurrents, the control unit may execute, on the second disconnection device, the power storage device disconnection control for disconnecting the power storage device from the power supply circuit, in the case where the state in which both the load device-side current and the power storage device-side current are overcurrents continues even though the load disconnection control has been executed, and the control unit may execute the power generation device disconnection control on the first disconnection device in the case where the state in which the power generation device-side current is an overcurrent continues even though the power storage device disconnection control has been executed. This can prevent the power generation device from stopping.

### Supplementary Note 4

In the power supply system according to Supplementary Note 1, the control unit may execute the load disconnection control on the drive device in the case where the state in which the load device-side current is an overcurrent continues for the first time period, and the control unit may execute the power generation device disconnection control on the first disconnection device in the case where the state in which the load device-side current is an overcurrent continues for the second time period that is longer than the first time period. This can prevent the power generation device from stopping.

### Supplementary Note 5

In the power supply system according to Supplementary Note 3, the control unit may execute the load disconnection control on the drive device in the case where the state in which the load device-side current is an overcurrent continues for the first time period, the control unit may execute the power storage device disconnection control on the second disconnection device in the case where the state in which the load device-side current is an overcurrent continues for the third time period that is longer than the first time period, and the control unit may execute the power generation device disconnection control on the first disconnection device in the case where the state in which the load device-side current is an overcurrent continues for the second time period that is longer than the third time period. This can prevent the power generation device from stopping.

### Supplementary Note 6

In the power supply system according to any one of Supplementary Notes 1 to 5, the drive device may include the switching element, and in the case where the control unit executes the load disconnection control, the switching element included in the drive device may be controlled to thereby disconnect the load from the power supply circuit. This can prevent the power generation device from stopping.

### Supplementary Note 7

The moving object (10) of the present disclosure includes the power supply system according to any one of Supplementary Notes 1 to 5. This can prevent the power generation device from stopping.

### Supplementary Note 8

The control method of the power supply system according to the present disclosure is a control method of the power supply system including: the power generation device configured to output DC power; the load device including the drive device configured to convert the DC power into AC power to drive the load; the power supply circuit configured to supply, to the load device, the DC power supplied from the power generation device; the first disconnection device configured to disconnect the power generation device from the power supply circuit; and the overcurrent determination unit configured to determine whether or not the load device-side current that is a current supplied from the power supply circuit to the load device is an overcurrent, the control method including: executing, on the drive device, the load disconnection control for disconnecting the load from the power supply circuit, in the case where the overcurrent determination unit determines that the load device-side current is an overcurrent; and executing, on the first disconnection device, the power generation device disconnection control for disconnecting the power generation device from the power supply circuit, in the case where the state in which the load device-side current is an overcurrent continues even though the load disconnection control has been executed. This can prevent the power generation device from stopping.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A power supply system comprising:
a power generation device configured to output direct current electric power;
a load device including a drive device configured to convert the direct current electric power into alternating current electric power to drive a load;
a power supply circuit configured to supply, to the load device, the direct current electric power supplied from the power generation device;
a first disconnection device configured to disconnect the power generation device from the power supply circuit; and
a control device configured to control the drive device and the first disconnection device, the control device comprising one or more processors that execute computer-executable instructions stored in a memory,
wherein the one or more processors execute the computer-executable instructions to cause the control device to:
determine whether or not a load device-side current that is a current supplied from the power supply circuit to the load device is an overcurrent;
execute, on the drive device, load disconnection control for disconnecting the load from the power supply circuit, in a case where it is determined that the load device-side current is the overcurrent; and
execute, on the first disconnection device, power generation device disconnection control for disconnecting the power generation device from the power supply circuit, in a case where a state in which the load device-side current is the overcurrent continues even though the load disconnection control has been executed.

2. The power supply system according to claim 1, wherein
the one or more processors cause the control device to:
further determine whether or not a power generation device-side current that is a current supplied from the power generation device to the power supply circuit is an overcurrent;
execute the load disconnection control on the drive device in a case where both the load device-side current and the power generation device-side current are overcurrents; and
execute the power generation device disconnection control on the first disconnection device in a case where a state in which the power generation device-side current is the overcurrent continues even though the load disconnection control has been executed.

3. The power supply system according to claim 2, further comprising:
a power storage device connected to the power supply circuit in parallel with the power generation device; and
a second disconnection device configured to disconnect the power storage device from the power supply circuit, wherein
the one or more processors cause the control device to:
further determine whether or not a power storage device-side current that is a current supplied from the power storage device to the power supply circuit is an overcurrent;
execute the load disconnection control on the drive device in a case where both the load device-side current and the power storage device-side current are overcurrents;
execute, on the second disconnection device, power storage device disconnection control for disconnecting the power storage device from the power supply circuit, in a case where a state in which both the load device-side current and the power storage device-side current are the overcurrents continues even though the load disconnection control has been executed; and
execute the power generation device disconnection control on the first disconnection device in a case where the state in which the power generation device-side current is the overcurrent continues even though the power storage device disconnection control has been executed.

4. The power supply system according to claim 1, wherein
the one or more processors cause the control device to:
execute the load disconnection control on the drive device in a case where the state in which the load device-side current is the overcurrent continues for a first time period; and
execute the power generation device disconnection control on the first disconnection device in a case where the state in which the load device-side current is the overcurrent continues for a second time period that is longer than the first time period.

5. The power supply system according to claim 3, wherein
the one or more processors cause the control device to:
execute the load disconnection control on the drive device in a case where the state in which the load device-side current is the overcurrent continues for a first time period;
execute the power storage device disconnection control on the second disconnection device in a case where the state in which the load device-side current is the overcurrent continues for a third time period that is longer than the first time period; and
execute the power generation device disconnection control on the first disconnection device in a case where the state in which the load device-side current is the overcurrent continues for a second time period that is longer than the third time period.

6. The power supply system according to claim 1, wherein
the drive device includes a switching element, and
in a case where the one or more processors cause the control device to execute the load disconnection control, the switching element included in the drive device is controlled to thereby disconnect the load from the power supply circuit.

7. A moving object comprising the power supply system according to claim 1.

8. A control method of a power supply system, the power supply system including:
a power generation device configured to output direct current electric power;
a load device including a drive device configured to convert the direct current electric power into alternating current electric power to drive a load;
a power supply circuit configured to supply, to the load device, the direct current electric power supplied from the power generation device; and
a first disconnection device configured to disconnect the power generation device from the power supply circuit,
the control method comprising:
causing one or more processors to determine whether or not a load device-side current that is a current supplied from the power supply circuit to the load device is an overcurrent;
causing the one or more processors to execute, on the drive device, load disconnection control for disconnecting the load from the power supply circuit, in a case where it is determined that the load device-side current is the overcurrent; and
causing the one or more processors to execute, on the first disconnection device, power generation device disconnection control for disconnecting the power generation device from the power supply circuit, in a case where a state in which the load device-side current is the overcurrent continues even though the load disconnection control has been executed.
